(19) United States
(12) Patent Application Publication
(10) Pub. No.: US 2005/0081155 A1
(43) Pub. Date: Apr. 14, 2005

(54) Virtual player capable of handling dissimilar content

(76) Inventors: Geoffrey Martin, Scotts Valley, CA (US); Frank E. LaFetra JR., Sunnyvale, CA (US); Janet L. Sailor, San Leandro, CA (US); Ruth Ann Lim, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/958,534

(22) Filed: Oct. 4, 2004

Related U.S. Application Data
(60) Provisional application No. 60/508,439, filed on Oct. 2, 2003.

(51) Int. Cl. G11B 27/00; G06F 3/00; G06F 17/24; G06F 17/21

(52) U.S. Cl. 715/719; 715/769; 715/716; 715/717; 715/718; 715/720; 715/767; 715/500.1; 715/524; 715/501.1; 348/425.3; 348/426.1; 715/516; 715/515

(57) ABSTRACT

One embodiment in accordance with the invention is a method for launching a graphical user interface player with a computing resource. A plurality of applications for accessing electronic content can be launched concurrently with the launching of the graphical user interface player. An electronic content can be automatically opened in response to the dropping of a pointer to the electronic content onto the graphical user interface player.

### CROSS REFERENCE TO RELATED APPLICATIONS

This patent application claims priority to the co-pending U.S. Provisional Patent Application No. 60/508,439 which has an Attorney Docket Number: ORGANIZE.PRO, and is entitled “A Novel Customizable User Interface For One Click Access To Local And Online Contents” by Geoffrey Martin et al., filed on Oct. 3, 2003, and assigned to the assignee of the present invention.

### BACKGROUND

Since the advent of the personal computer, there are many software applications available which allow one to perform a wide range of tasks with a personal computer. It is understood that each software application is essentially a tool that allows its user to perform a task with the computer. For example, a picture viewing software application can enable a computer user to view digital images while a music player software application can enable the computer user to listen to digital music files or streaming audio (e.g., from the Internet). Furthermore, a video presentation software application can enable the user to view digital movies or video.

However, there are disadvantages associated with these types of media player software applications. One of the disadvantages is that for each different type of media file that a user desires to access, a different media player application typically has to be turned on or “launched” as it is needed during the user experience. For example, one way of launching a desired media application from an on-screen desktop is by the user locating its specific icon (or an icon for the desired file associated with that application) and then selecting it with a cursor control device, such as, a mouse, track-pad, and the like. This technique can become burdensome as more and more icons take their place on the desktop resulting in that user environment becoming more and more chaotic. Additionally, viewing or playing heterogeneous media content generally involves using several different media players, each with its own user interface that the user typically has to negotiate in order to use it.

Another possibility is for the user to utilize a graphical user interface (GUI) of the computer to find the desired media application or the desired media file associated with it on the hard drive and launch it from there. However, this process can be overwhelming for the beginning user.

A software application can provide a single set of player controls to allow the user to play a range of media files if it handles many media file types natively. Handling different data types using the same interface typically comes at the cost of a great deal of code development. Because of this complexity, many software applications that support multiple files types do so by converting the original media file to a type that is supported natively by the player. Minimally, this approach typically involves developing logic for a media player that supports at least one media file type.

The present invention may address one or more of the above issues.

### SUMMARY

One embodiment in accordance with the invention is a method for launching a graphical user interface player with a computing resource. A plurality of applications for accessing electronic content can be launched concurrently with the launching of the graphical user interface player. An electronic content can be automatically opened in response to the dropping of a pointer to the electronic content onto the graphical user interface player.

### BRIEF DESCRIPTION OF THE DRAWINGS

FIG. 1 is a block diagram of an exemplary graphical user interface (GUI) in accordance with embodiments of the invention.

FIG. 2 is a diagram depicting an exemplary category of the graphical user interface of FIG. 1 in accordance with embodiments of the invention.

FIG. 3 is a block diagram illustrating the exemplary common-ground nature of a graphical user interface in accordance with embodiments of the invention.

FIG. 4 is a block diagram of an exemplary GUI multi-purpose player window in accordance with embodiments of the invention.

FIG. 5 is a block diagram of another exemplary GUI multi-purpose player window in accordance with embodiments of the invention.

FIG. 6 is a flowchart of a method in accordance with embodiments of the invention for opening content.

FIG. 7 is a flowchart of another method in accordance with embodiments of the invention for opening content.

FIG. 8 is a flowchart of yet another method in accordance with embodiments of the invention for opening content.

### DETAILED DESCRIPTION

Reference will now be made in detail to embodiments in accordance with the invention, examples of which are illustrated in the accompanying drawings. While the invention will be described in conjunction with embodiments, it will be understood that these embodiments are not intended to limit the invention. On the contrary, the invention is intended to cover alternatives, modifications and equivalents, which may be included within the scope of the invention as defined by the appended claims. Furthermore, in the following detailed description of embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

Embodiments in accordance with the invention can present a more uniform user interface for playing different media file types (or content file types). The non-player portion of the user interface can work together with the player user interface to unify the methods of loading the various media file types into the virtual player. The non-player user interface may supply its own file association feature distinct from the associations set by an operating system. Embodiments of the invention can present a user with a single set of user interface controls shared by the players of several media types such that the user experiences a single player capable of playing several types of media files. As such, embodiments of the invention can avoid the cost of developing a media player and common media data format to which other files types may be converted.

Instead, embodiments of the invention can take the capabilities provided by players implemented according to the Common Object Model (COM) standard (or similar standards or technologies) and can map each exposed player control to a set of user interface controls provided not by each player but by the virtual player in accordance with embodiments of the invention. Embodiments of the invention can thus provide a user interface that one can think of as a “virtual player,” since the code that can actually process the data in the media file can be actually one of the many media players implemented as a COM object (or similar standards or technologies) available in the marketplace today. Embodiments of the invention can use the COM object player (or similar standards or technologies) in an unconventional way, because instead of simply allowing the COM object to present its own user interface to the user, embodiments of the invention can control the COM object player through a user interface (e.g., the virtual player) provided by embodiments of the invention. This can allow embodiments of the invention to use the same user interface controls for recognized media file types both for putting of the media file into the player and to control the playback.

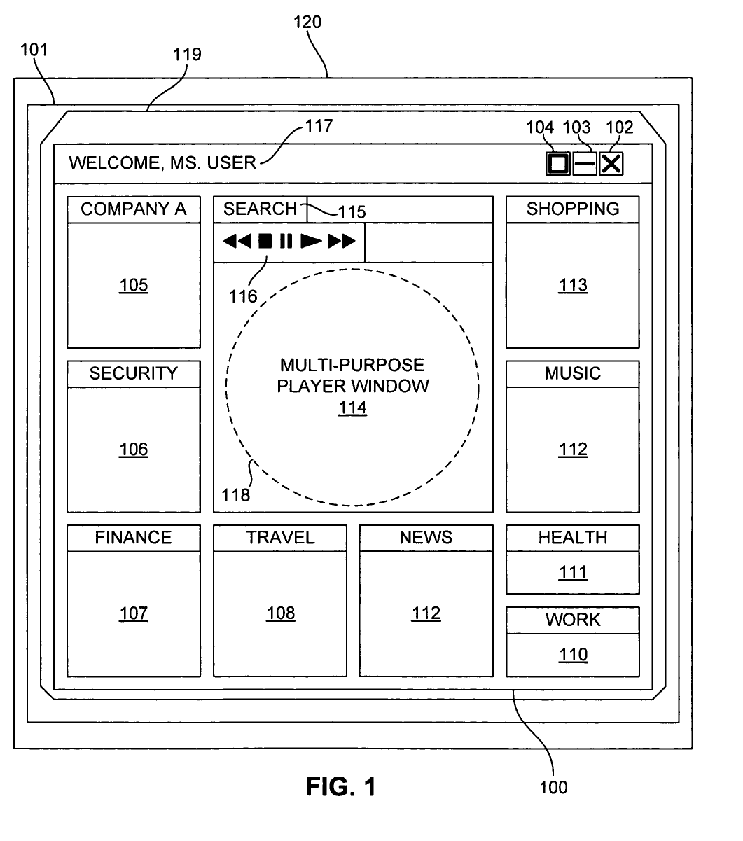

FIG. 1 is a block diagram of an exemplary graphical user interface (GUI) 100 in accordance with embodiments of the invention as it may appear on an on-screen desktop 101 of a display device 120 coupled to a computing resource (not shown). The GUI 100 can include a multi-purpose player window 114 that enables its user to display or access numerous and multiple file types (or content types) while player window 114 remains as the user interface for those dissimilar accessed files. Moreover, the player window 114 can do this without the user knowing which application the file (content) is associated with and without the user having to open numerous applications to display or access a group of dissimilar files (or content). Besides including the multi-purpose player window 114 for launching electronic content, the GUI 100 can include one or more category modules (e.g., 105-113), and a search bar 115 for searching a network such as the Internet or memory (e.g., hard drive) of the computing resource. It is appreciated that GUI 100 may include variations of the elements shown by FIG. 1. Furthermore, GUI 100 may not include all of the elements illustrated by FIG. 1. For example, the GUI multi-purpose player 114 of the GUI 100 can be implemented as a standalone application, as described herein. Note that the GUI multi-purpose player 114 can also be referred to as a GUI that includes a content player, a virtual player, a multi-purpose player window, or a multi-purpose player.

It is understood that the electronic content can be implemented in a wide variety of ways in accordance with embodiments of the invention. For example, the electronic content can be implemented as, but is not limited to, any type of media file, any type of music (or audio), any type of video, any type of graphics presentation (e.g., a Microsoft® PowerPoint® presentation), any type of digital image, any type of word processor document, any type of spreadsheet, any type of text, any type of streaming video, any type of streaming audio, any type of Internet radio, and the like. Additionally, it is appreciated that the computing resource can be implemented in a wide variety of ways in accordance with embodiments of the invention. For example, the computing resource can be implemented as, but is not limited to, any type of computing device, any type of computer system, any type of portable computing device, any type of portable computer system, a workstation computer system, a server computer, a main-frame computer system, and the like.

The multi-purpose player 114 of FIG. 1 can launch multiple forms of media or content while remaining the user interface for the dissimilar forms of content. For example, the multi-purpose player 114 can display electronic pictures, play electronic videos, play electronic music, display electronic text, display word processor documents, display electronic spreadsheets, display graphic presentations, as well as other media file types, but is not limited to such. It is appreciated that the multi-purpose player 114 can also be referred to as a virtual player 114, a media player 114, a GUI player 114, a content player 114, a universal content player 114, or a universal media player 114.

The multi-purpose player window 114 can include a sensitive (or activation or detecting) area 118 for launching selected content. Note that sensitive area 118 can be implemented in a wide variety of sizes. For example, the sensitive area 118 can be implemented to be larger than the multi-purpose player window 114 or any size smaller than that. It is appreciated that a user can open or launch electronic content referred to by a link (or pointer) by dragging and dropping the link onto the sensitive area 118 of multi-purpose player window 114. Moreover, a user can also open or launch content by dragging and dropping the specific content onto the sensitive area 118 of multi-purpose player window 114. Note that any content link or any content itself can be dragged by a user from any category (e.g., 105-113) within the GUI 100, or from a desktop (e.g., 101) of the computing resource, or from any file organization of the computing resource, or from another application and dropped onto the sensitive area 118 of multi-purpose player window 114. The multi-purpose player window 114 can include optional controls 116 that can be associated with the type of content it is opening and presenting. For example, the optional controls 116 can include, but are not limited to, a play “button,” a rewind “button,” a fast forward “button,” a pause “button,” a stop “button,” a volume control, a progress bar, and the like. Exemplary functions and/or operations that can be associated with the multi-purpose player window 114 in accordance with embodiments of the invention are described herein.

It is noted that FIG. 1 can represent an exemplary “non-player” user interface capable of interacting with the user interface of the virtual player 114. Within FIG. 1, the GUI 100 can include various category modules such as, but is not limited to, a “Company A” category module 105, a “Security” category module 106, a “Finance” category module 107, a “Travel” category module 108, a “News” category module 109, a “Work” category module 110, a “Health” category module 111, a “Music” category module 112, and a “Shopping” category module 113. Note that GUI 100 can be implemented with any number of category modules. For example, GUI 100 can include a greater or fewer number of category modules than those shown in FIG. 1. A category module can include one or more links (or pointers) to content online as well as in the memory (e.g., hard drive) of the computing resource the GUI 100 can be installed on. In one embodiment, categories can also contain links (or pointers) to content found on other computers in a network. The GUI 100 can be supplied to the user already equipped with default categories containing links (or pointers) to content online and in the memory (e.g., hard drive) of the computer. The GUI 100 can be configured by its manufacturer with certain pre-defined modules. The category modules (e.g., 105-113) can each be customized by a user, or the user may use them as they are originally defined. Whether or not the user alters them, each category module can be implemented to carry a unique identifier which does not change. This can allow the manufacturer or a permitted business partner to monitor changes made by the user. It is understood that all such data-collection can adhere to a privacy statement made available to and agreed to by the user. To interact with the virtual player 114, a category module user interface (e.g., one or 105-113) can create an association between the handling of supported media data (or content data) represented by the entry within the category and/or the virtual player.

GUI 100 can include a customizable “skin” 119 that can allow a user to alter the appearance of GUI 100 along with background images without affecting functionality of GUI 100. As such, the skin 119 of the GUI 100 can be user-customizable. Additionally, the skin 119 can also be modified by a third party through the Internet or other network. In this way, the GUI 100 can be used by selected business partners as an advertising tool, a recruiting tool, and the like. The GUI 100 can include a “button” 102 for closing GUI 100, a “button” 103 for minimizing the viewable size of GUI 100, and a “button” 104 for “maximizing” the viewable size (e.g., full screen mode) of GUI 100. The user can change the size of the GUI 100 and the location of the GUI 100 on the display screen 100. The GUI 100 can also include a personalized greeting bar 117. In one embodiment, upon registration of the software which can render the GUI 100, the user may provide personal information, thereby allowing GUI 100 to greet him or her personally utilizing greeting bar 117.

Within FIG. 1, once the GUI 100 is installed on his or her computing resource, the user can begin to customize GUI 100. The user can modify the skin 119 of the GUI 100. The user can alter the titles of the categories (e.g., 105-113), hide categories, delete categories, add new categories, move categories around within the GUI 100, and change the sizes of the categories. The user can also delete, modify and add new links or pointers to categories (e.g., 105-113). The user can choose where a particular link can be displayed within a category. In one embodiment, all pre-defined categories can have a unique identifier. While a user may change the title of the category or the links (or pointers) contained within it, the unique identifier can be non-customizable. The GUI 100 can support a “reset to defaults” functionality which hides user-defined categories and links and restores GUI 100 to its original appearance. Note that a key customization can be the setting that allows the user to specify whether the links to media files (or content files) within a category should use the file association defined by the operating system to launch a third-party media player or whether links to media files (or content files) should use the file association mechanism controlled by the virtual content player 114. The operating system file association can be used in all cases where the virtual content player 114 does not have its own file association covering the selected file type (or content type).

Applications appropriate (or capable of) for accessing content referred to by links (or pointers) within the categories 105-113 of the GUI 100 can each be initially launched concurrently with the launching of the GUI 100 itself. Note that the link can launch a third-party media (content) player concurrently with the GUI 100, or the link can pass the referenced media file (content) to the virtual player 114. The GUI 100 can be equipped with a content (or file) association table (e.g., see Table 1 below) that would enable the virtual player 114 to process the media file (content) appropriately. The content association table can enable the GUI 100 to analyze content links (or content pointers) and content in order to determine which application is capable of (or appropriate for) accessing or opening user-selected content. For example, the user may select content by dragging and dropping a content link or content itself onto the sensitive area 118 of the multi-purpose player window 114. Since appropriate applications have each been loaded into memory and are each idle or dormant in the background of GUI 100, it can be all but instantaneous when the GUI 100 opens the desired content.

For example, when the user drags and drops a link that is a Uniform Resource Locator (URL), e.g., “http://www.hp.com”, onto the sensitive area 118 of multi-purpose player 114, the GUI 100 can detect that an Internet browser can be an appropriate application for accessing the desired content. It is appreciated that the Internet browser can be one of the applications that was initially launched while the GUI 100 was being launched. Note that the user can pre-select the Internet browser application he or she would like to use, and the browser employed by the GUI 100 may be different from the Internet browser employed by an operating system of the computing resource.

Within FIG. 1, once the appropriate application is determined, the GUI 100 can then use API (application programming interface) commands to instruct the appropriate application what to do. In the example of a URL, the GUI 100 can utilize API commands to instruct an Internet browser to open the content referred to by the URL. Furthermore, when the user drags and drops a content link such as “MySummerVacation.doc” onto the sensitive area 118, the GUI 100 can detect that a word processor application is appropriate for accessing the selected content. The GUI 100 can then use API commands to instruct the word processor application to open the selected content (or file).

Table 1 shown below is an example of a content (or file) association table in accordance with embodiments of the invention that GUI 100 can use to determine an application that is capable of (or appropriate for) accessing or opening content. It is appreciated that Table 1 is not an exhaustive list of file types. Therefore, a greater or fewer number of file types can be included as part of Table 1.

TABLE 1

| | APPROPRIATE APPLI- | WHAT DOES GUI |
|---|---|---|
| FILE | CATION FOR | COMMUNICATE TO |
| EXTENSION | ACCESSING CONTENT | APPLICATION? |
| .doc | Word Processor | API commands for Word |
| | Software | Processor application |
| .xls | Spreadsheet | API commands for |
| | Software | Spreadsheet application |
| . | . | . |
| . | . | . |
| . | . | . |
| .mov | Video Player Software | API commands for Video |
| | | Player application |
| .mpeg | Music Player Software | API commands for Music |
| | | Player application |

Specifically, the GUI 100 can utilize metadata associated with a link (and/or content) to determine which application is capable of accessing the content. For example, applications that operate in combination with an operating system can include a file extension as part of a file name such as “.mpeg” which is metadata indicating the application capable of accessing that content. As such, the GUI 100 can consult a content (or file) association table similar to Table 1 to determine which application can be employed to access the content. It is appreciated that including metadata as part of a file name is exemplary and that embodiments of the invention are not limited to such. Metadata can be associated with a link (or pointer) and/or content in a wide variety of ways. Note that in whatever way metadata can be associated with a link and/or content, it can be utilized to identify what the content is and its appropriate engine.

Table 1 includes a “File Extension” column, an “Appropriate Application For Accessing Content” column, and a “What Does GUI Communicate To Application?” column. As such, when the GUI 100 reads a file extension (e.g., metadata) of a pointer to content, it can utilize a content association table similar to Table 1 to determine the appropriate application for accessing the content (from its associated column) along with the protocol used for communicating and controlling the application (from its associated column).

In one embodiment of the invention, when the user selects a link (e.g., by dragging and dropping it onto the sensitive area 118 of multi-purpose player 114), the GUI 100 can use a file association table (e.g., see Table 1) to map the requested content to an appropriate application. In this way, the GUI 100 can match the content (or file) type with a proper application, which may have already been launched with the launching of the GUI 100. The GUI 100 can instruct the proper application with application programming interface (API) commands, and the content can be opened with an appropriate application and the multi-purpose player 114 can be the user interface for that content.

Certain categories of GUI 100 can be pre-defined to open content with a certain application. This type of category can be referred to as a specialized category. The GUI 100 can contain at least one specialized category. A specialized category can be predefined such that any content referred to by a link within the specialized category can be automatically open in an application determined (or predefined) by a content association table of the GUI 100. For example, one embodiment of the GUI 100 can contain a specialized category called “Music” 112. All content referred to by links or pointers within the Music category 112 can be automatically opened in a music media player application, while utilizing the GUI multi-purpose player 114 as the user interface for that content. Note that if a link or pointer is dragged from a specialized category (e.g., 112) and dropped onto the sensitive area 118 of the multi-purpose player 114, the GUI 100 may not consult a content association table. Instead, the content can be opened in the application designated as the primary application for that specialized category.

Within FIG. 1, it is noted that a link or pointer to a music file may be placed in any of the categories of GUI 100, such as a general category called “Shopping” 113. However, when the user selects a link or pointer to a music file located in the Shopping category 113, the GUI 100 can utilize an operating system's content (or file) association table of the computing resource to determine which music player application can be appropriate for automatically opening the music file. Conversely, when the user selects a pointer or link to a music file located in the specialized Music category 112, the GUI 100 can consult its own content association table and automatically open the music file in an appropriate music player application, without using the operating system's file association table. It is noted that the user can choose to put a non-music content link into the Music category 112. When a user selects the non-music link, the GUI 100 can first attempt to open its associated content using a music player application. If that fails, the GUI 100 can then use the operating system's content association table to determine which application can be appropriate for accessing (or opening) the desired content.

It is appreciated that the changes made by the user to customize GUI 100 can be recorded so that an administrator of GUI 100 can evaluate the user's use of GUI 100. Data recorded for this purpose can be maintained in the form of a user profile (not shown), which can be read by GUI 100's underlying processes or an external process. A user profile and data files can be made available to the GUI 100 administrator and its business partners, in a way that can be compatible with the privacy policies agreed to by the user. For example, the GUI 100 may accumulate statistics on the number of user-defined links and categories, without gathering data regarding the specifics of the content. Furthermore, the GUI 100 may record data such as how many user-defined links the user creates and how often in aggregate the user uses the user-defined links and how many user-defined links are for local content versus network content. Note that the GUI 100 can be capable of compiling other useful information, such as but not limited to, a measure of user click-throughs (or selections) from GUI 100 to partner links and applications, a list of most frequently used applications, and a list of most frequently used websites. Business partners can utilize these statistics to evaluate the effectiveness of their products and advertisement campaigns.

Within FIG. 1, the user profile may contain information regarding the behavioral logic of the user that may establish an association between the user and a selected business partner. For instance, the behavioral logic information may indicate from which retailer the user purchased the computing resource upon which the GUI 100 application is operating. In that case, an association can be made in which the user can be a customer of the selected business partner, the retailer from which the user purchased the computing resource.

The GUI 100 can be implemented to provide means to promote selected business partners' interests. For instance, in one embodiment, the GUI 100 can provide space for a selected business partner to prominently display their name, logo, and/or to advertise their name in a banner. Furthermore, a category module (e.g., 105) could be created by a selected business partner that includes links or pointers to websites, picture files, music files, video files, presentation files, etc., which advertise the products or services offered by that business partner. It is appreciated that the user may choose to explore these supplied links, or to delete the supplied category. The user's use or lack thereof can become part of his or her user profile.

Within FIG. 1, one of the benefits of the GUI 100 can be that it allows for revenue sharing, in one embodiment of the invention. For example, whenever one of the links (or pointers) provided within the GUI 100 is selected, engaged, or activated, revenue sharing can be implemented between companies associated with the activation of that link. For instance, if a user activated the search function 115, the GUI 100 may link the user to a particular search engine that displays advertisements, from which the search engine can provide some revenue sharing to various related partners, such as the manufacturer of the computing resource, or the manufacturer of the GUI 100 application, etc.

In one embodiment, a partner specific GUI 100 can be displayed to the user upon initial activation of the GUI 100. For example, when the GUI 100 is operating on the computing resource, a skin (e.g., 119) and one or more categories (e.g., 105-113) containing links or pointers associated with a specific business partner can be presented to the user. In this case, the partner-specific GUI can be the default display for the GUI 100. The user can use the GUI 100 in this form, or customize the GUI 100 as desired.

Within FIG. 1, the GUI 100 can include search bar (or tool) 115. Using search tool 115, the user can search for content stored by memory of the computing resource or a network with a search engine. For example, when the user enters text or a phrase into the search bar (or tool) 115, the GUI 100 can automatically send the search request to a search engine on a network, such as the Internet, but is not limited to such. This can be a specific user-selected search engine (e.g., online), or a combination of search engines (e.g., online). A web page can display the results of this search to the user on the display 120. As previously noted, the search tool (or bar) 115 can also be used to search content stored on the local computing resource.

Note that the multi-purpose player window 114 can be implemented in any manner similar to that described herein, but is not limited to such.

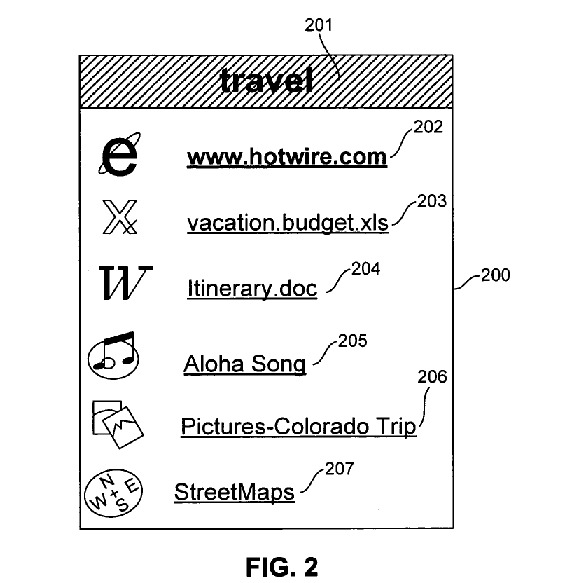

FIG. 2 is a diagram depicting an exemplary category 200 of the graphical user interface 100 (FIG. 1) in accordance with embodiments of the invention. It is noted that the title 201 of category 200 can be modified by a user and/or a third party. The category 200 can include one or more links or pointers to online content (e.g., 202), content (e.g., 203) stored by computing resource memory (e.g., hard drive), and/or content stored by one or more network computer resources. Note that category 200 can include a wide variety of links or pointers to content stored by computing resource memory (local and/or network). For example, category 200 can include, but is not limited to, a spreadsheet link 203, a word processor document link 204, a music content link 205, a picture content link 206, and/or an application link 207. It is understood that category 200 can be implemented to include one or more links that are a particular type of link or pointer (e.g., 205). For example, category 200 can be implemented to include one or more picture content links (e.g., 206).

The category 200 of GUI 100 can be configured by the manufacturer with certain predefined links or pointers. The links can be customized by the user, or the user may use them as they are originally supplied. Predefined links may be hidden by the user, yet retained as a default setting. In one embodiment, the appearance of a link in category 200 can visibly change when the content referred to by the link changes, whether the content is online or stored by memory (e.g., hard drive) of the computing resource. For example, the font of the link or pointer (e.g., 202) to content that has changed may appear in bold font, while the other links (e.g., 203-207) do not appear in bold font. If the content referred to by a link or pointer can be erased, deleted, omitted or ceases to exist, the link can be deleted from the user's view in GUI 100. For instance, the link or pointer can be deleted from each category (e.g., 200) that it is included within GUI 100. The selection of a link to online content can trigger an Internet browser application to go to a desired Uniform Resource Locator (URL) and display the selected content from the Internet. In another embodiment, online content can be cached at predetermined intervals. The selection of a link to cached content can trigger the GUI 100 to display cached Internet content.

Within FIG. 2, category 200 of GUI 100 can have a unique identifier. The unique identifier can allow a third party (e.g., a GUI 100 administrator) to properly match and track any pre-defined category (e.g., 200) back to the default definition of the pre-defined category, regardless of how the user has renamed the category. The unique identifier may not be implemented the same as the category title (e.g., 201) displayed to the user. In one embodiment, user-defined categories appear distinctly different from pre-defined categories within the GUI 100.

It is noted that each category (e.g., 105-113) of the GUI 100 can function and/or operate in any manner similar to that described herein with reference to category 200, but is not limited to such.

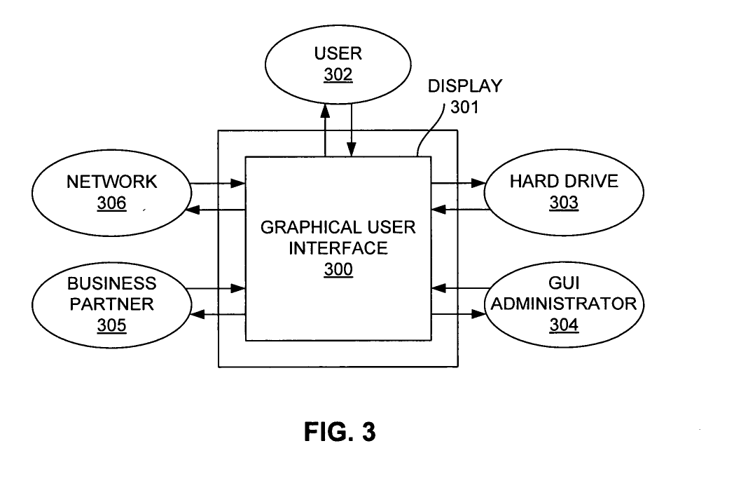

FIG. 3 is a block diagram illustrating the exemplary common-ground nature of a graphical user interface (GUI) 300 in accordance with embodiments of the invention. The GUI 300 can be displayed by a display device 301 thereby enabling a user 302 to view and utilize it. Through the GUI 300, the user 302 can access content from a network 306 as well as a hard drive (or any other memory) 303 of a computing resource (not shown). The user 302 can also send content out to network 306 by utilizing the GUI 300. In one embodiment, a GUI administrator 304 and the GUI administrator's business partners 305 can communicate directly with the user 302 through the GUI 300 over one or more networks (e.g., the Internet) 306. As the user 302 personalizes (or customizes) and utilizes the GUI 300, the GUI administrator 304 and the business partners 305 can begin to formulate a profile of the user 302, and tailor communications to the user 302 through the GUI 300 that can be based on this profile.

Communications can be sent to the user 302 through the GUI 300 via push technology. It is understood that push technology is an Internet technology that can send prearranged information to users (e.g., 302) before they actually request it. The type of information that can be sent via push technology can be determined in part by utilizing the user's profile. In one embodiment, communications to the user 302 or changes to the appearance of the GUI 300 can be set to occur at predetermined times, for example around holidays of the year.

It is noted that GUI 100 can function and/or operate in any manner similar to that described herein with reference to GUI 300, but is not limited to such.

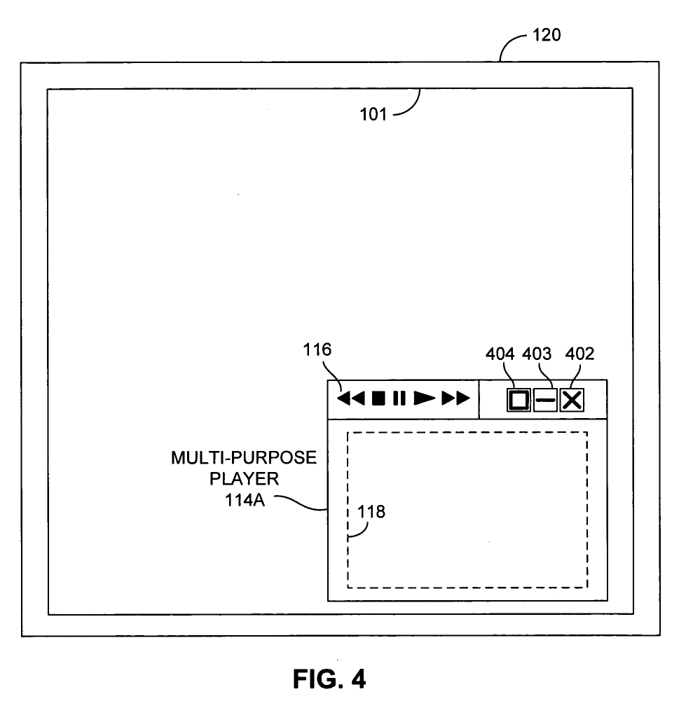

FIG. 4 is a block diagram of an exemplary GUI multi-purpose player window 114a in accordance with embodiments of the invention as it may appear on a display device 120 that is coupled to a computing resource. The multi-purpose player window 114a can enable its user to access numerous and multiple file types (or content types) while player window 114a remains as the user interface for the dissimilar accessed files. Furthermore, the player window 114 can do this without the user knowing which application the file (content) is associated with and without the user having to open numerous applications to display or access a group of dissimilar files (or content). Note that the GUI multi-purpose player window 114a can be a stand-alone application that can be displayed and utilized without the other components of GUI 100, such as but not limited to, one or more categories (e.g., 105-113) and/or a search tool (e.g., 115). However, it is appreciated that the GUI multi-purpose player 114a can operate in any manner similar to any of the operations associated with the multi-purpose player window 114 described herein.

Note that the GUI multi-purpose player 114a can also be referred to as a GUI that includes a content player, a virtual player, a multi-purpose player window, or a multi-purpose player. It is appreciated that the multi-purpose player 114a can also be referred to as a virtual player 114a, a media player 114a, a GUI player 114a, a content player 114a, a universal content player 114a, or a universal media player 114a.

The GUI multi-purpose player 114a can be moved (e.g., by a user) to any location on the desktop 101. Additionally, the GUI multi-purpose player 114a can be implemented so that the user can modify its size. It is understood that the sensitive (or activation or detector) area 118 can be implemented to be larger than multi-purpose player 114a, approximately the same size as multi-purpose player 114a, or smaller than the multi-purpose player 114a. Additionally, the GUI multi-purpose player 114a can optionally include a “button” 402 for closing the GUI multi-purpose player 114a, a “button” 403 for minimizing the viewable size of the multi-purpose player 114a, and a “button” 404 for “maximizing” the viewable size (e.g., full screen mode) of the multi-purpose player 114a.

Within FIG. 4, it is appreciated that any content link or any content itself can be dragged by a user from desktop 101 of the computing resource, or from any file organization of the computing resource, or from another application and dropped onto the sensitive area 118 of multi-purpose player window 114a. As such, the GUI player 114a can determine an application capable of accessing the content referred to by the link or the content itself. The GUI player 114a can then use API commands to instruct the application to open the selected content.

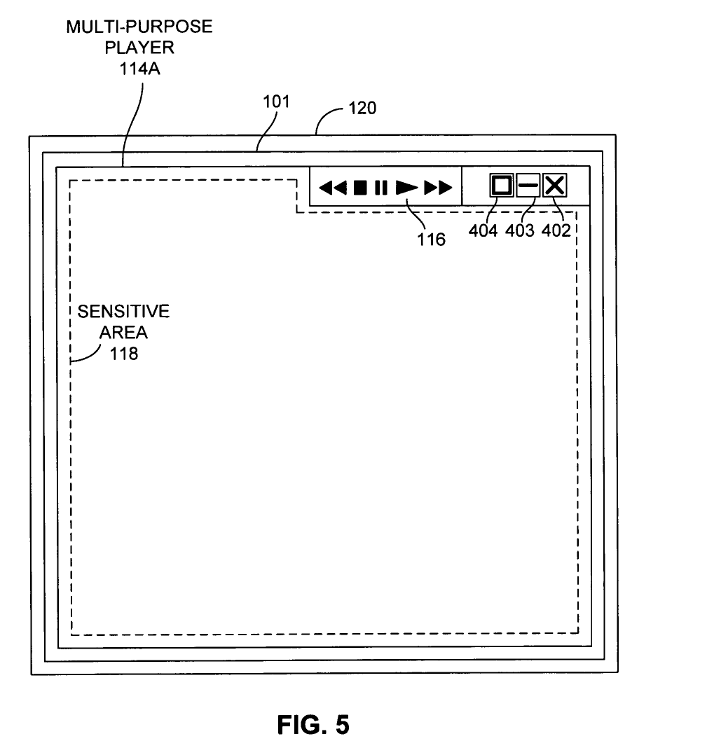

FIG. 5 is a block diagram of GUI multi-purpose player window 114a having its viewable size “maximized” in accordance with embodiments of the invention as it may appear on display device 120 coupled to a computing resource. For example, “button” 404 of the GUI multi-purpose player 114a may have been selected by a user resulting in maximizing the viewable size (e.g., approximately full screen) of the GUI multi-purpose player 114a. It is appreciated that when the viewable size of the GUI multi-purpose player 114a has been maximized, the sensitive area 118 can change accordingly. For example, the sensitive area 118 can increase to the size of the GUI multi-purpose player 114a or to some size smaller than GUI multi-purpose player 114a.

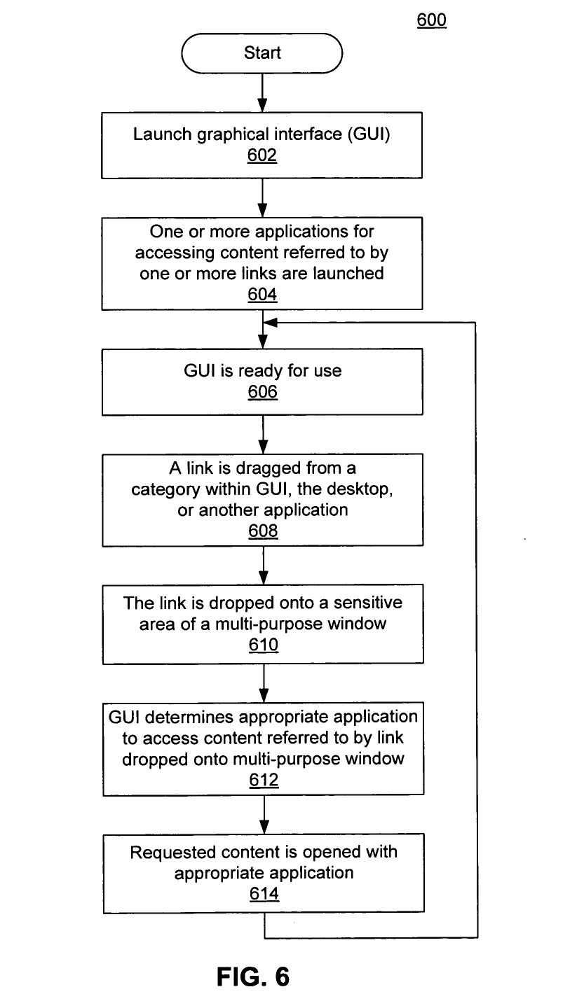

FIG. 6 is a flowchart of a method 600 in accordance with embodiments of the invention for opening electronic content. Method 600 includes exemplary processes of embodiments of the invention which can be carried out by a processor(s) and electrical components under the control of computing device readable and executable instructions (or code), e.g., software. The computing device readable and executable instructions (or code) may reside, for example, in data storage features such as volatile memory, non-volatile memory, and/or mass data storage that are usable by a computing device. However, the computing device readable and executable instructions (or code) may reside in any type of computing device readable medium. Although specific operations are disclosed in method 600, such operations are exemplary. That is, method 600 may not include all of the operations illustrated by FIG. 6. Alternatively, method 600 may include various other operations and/or variations of the operations shown by FIG. 6. Likewise, the sequence of the operations of method 600 can be modified. It is noted that the operations of method 600 can each be performed by software, by firmware, by hardware, or by any combination thereof.

Specifically, a graphical user interface (GUI) can be launched or started-up by a computing resource. Additionally, one or more applications for accessing electronic content that is referred to by any links can be launched by the computing resource. It is noted that the GUI can launch the one or more applications. Subsequently, the GUI can be ready for use. A link or pointer referencing electronic content can be dragged from a category within the GUI, from an on-screen desktop, or from another application. The link can then be dropped onto a sensitive area of a multi-purpose player window. As such, the GUI can determine which application is capable of (or appropriate for) accessing the content referred to by the dropped link. The requested electronic content can then be opened with the appropriate application while utilizing the multi-purpose player window as the user interface for that content. Method 600 can then return to where the GUI is ready for use. Note that if any other link is dragged and dropped onto the sensitive area of the multi-purpose player window, the GUI can determine which application is capable of accessing the content and then can open it with the appropriate application while the multi-purpose player window remains as the user interface for that content.

At operation 602 of FIG. 6, a graphical user interface (GUI) (e.g., 100) can be launched by a computing resource. It is appreciated that operation 602 can be implemented in a wide variety of ways. For example, the GUI can be automatically launched at operation 602 during startup of the computing resource. Alternatively, the GUI can be launched at operation 602 in response to a user selecting it to be started up. In another embodiment, the GUI can be automatically launched at operation 602 by another application. Operation 602 can be implemented in any manner similar to that described herein, but is not limited to such.

At operation 604, one or more applications capable of accessing or opening electronic content referred to by links or pointers within the GUI can be launched by the computing resource. It is understood that operation 604 can be implemented in diverse ways. For example, operation 604 can be implemented to occur concurrently with the launching of the GUI at operation 602. For example, as the GUI is being launch at operation 602, it can automatically initiate operation 604. It is appreciated that the one or more applications of operation 604 can be implemented as any type of electronic content “player” engine. For example, the content player engine can be implemented as, but is not limited to, any type of music (or audio) player application engine, any type of video player application engine, any type of graphics presentation application engine, any type of digital image application engine, any type of slide display application engine, any type of photo display application engine, any type of word processor application engine, any type of spreadsheet application engine, any type of text application engine, and the like.

Note that some types of applications that can be launched at operation 604 can essentially include two main components. The first component can be the application's user interface and the second component can be the application's content engine which can be thought of as a software library or software module. At operation 604, the user interface and the content engine of each application can be loaded into memory of the computing resource. It is noted that the GUI may not utilize the user interface of the application, whether or not it is loaded into memory. As such, the loaded user interface can later be over written in memory. It is appreciated that once the one or more applications have been launched at operation 604, each can remain idle or dormant in the background of the GUI. Note that as part of launching the one or more applications at operation 604, each application can be linked into the GUI.

At operation 606 of FIG. 6, the GUI is ready for use. It is understood that the GUI can be utilized by one or more users of the computing resource, but is not limited to such. The GUI of operation 606 can be implemented in any manner similar to that described herein, but is not limited to such.

At operation 608, a link or pointer referencing electronic content can be dragged from, but is note limited to, a category within the GUI, from an on-screen desktop of the computing resource, from any file organization of the computing resource, or from another application. Note that operation 608 can be implemented in a wide variety of ways. For example, the link or pointer at operation 608 can be implemented as, but is not limited to, any type of Uniform Resource Locator (URL), any type of file name, any type of content name, and the like. It is appreciated that multiple links or pointers can simultaneously be dragged at operation 608. For example, multiple pointers can be selected by a user and then dragged from, but is not limited to, a category within the GUI, from an on-screen desktop of the computing resource, from any file organization of the computing resource, or from another application. Alternatively, at operation 608, a folder or directory that includes multiple pointers (or links) can be dragged from, but is not limited to, a category within the GUI, from an on-screen desktop of the computing resource, from any file organization of the computing resource, or from another application. Note that the electronic content can be implemented in a wide variety of ways. For example, the electronic content can be implemented in any manner similar to that described herein, but is not limited to such.

At operation 610 of FIG. 6, the link or pointer can then be dropped onto a sensitive area (e.g., 118) of a multi-purpose player window (e.g., 114). It is appreciated that operation 610 can be implemented in diverse ways. For example, the multi-purpose player window can be implemented in any manner similar to that described herein, but is not limited to such. Furthermore, the sensitive area or region can be implemented in any manner similar to that described herein, but is not limited to such. Note that the sensitive area or region can be referred to as a sensor area or region, an activation area or region, a detection area or region, or a detector area or region.

At operation 612, the GUI can determine which application is capable of (or appropriate for) accessing the content referred to by the dropped link (or links). Operation 612 can be implemented in a wide variety of ways. For example, the GUI can utilize metadata associated with the link and/or the content to determine which application is capable of accessing the content referred to by the selected link. For instance, applications that operate in combination with an operating system can include a file extension as part of a file name such as “.jpg” which is metadata indicating the application capable of accessing that content. As such, the GUI can consult a content (or file) association table (e.g., see Table 1) at operation 612 in order to determine which application can be employed to access the content referred to by the selected link. It is appreciated that including metadata as part of a file name is exemplary and that embodiments of the invention are not limited to such. Metadata can be associated with a link (or pointer) and/or content in a wide variety of ways. Note that in whatever way metadata can be associated with a link and/or content, it can be utilized to identify what the content is and its appropriate engine. It is appreciated that if there are multiple links, operation 612 can determine them in a grouping manner. For example, if there are links referring to different applications, operation 612 can determine which application has the most links associated with it (e.g., using any method described herein), and then assign that application as the chosen one for that group of particular links. Alternatively, if there are links referring to different applications, operation 612 can identify (e.g., using any method described herein) and list each application. Note that the list can subsequently be used at operation 614.

At operation 614 of FIG. 6, the requested electronic content can then be opened with (or in) the appropriate application while utilizing the multi-purpose player window as the user interface for that content. It is understood that operation 614 can be implemented in diverse ways. For example, if the electronic content is a digital image, an application capable of opening the digital image is utilized to do so and can be instructed by the GUI to display that digital image within the multi-purpose player window, wherever it is located on the display. It is noted that for the GUI to open particular electronic content, an engine capable of opening (or accessing) may need to be resident to the computing resource or available to the computing resource (e.g., via another computing resource).

It is appreciated that at operation 614, more than one electronic content can be concurrently opened (or accessed) by one or more appropriate applications. For example, at operation 614, music content can be opened by a music player engine while digital slide content is opened by a slide player engine and then sized and displayed within the multi-purpose player window on the display. Alternatively, if a directory (or folder) of links to digital images was dropped at operation 610, for example, the digital images can each be opened at operation 614 by an appropriate image engine and then sized and displayed within the multi-purpose player window on the display in a slideshow format (e.g., displaying one image after another). Furthermore, if a directory (or folder) of links to digital songs was dropped at operation 610, for example, the digital songs can each be opened (or played) at operation 614 by its appropriate music engine in their entirety, one after another (or in random order), while appropriate music user interface controls (e.g., 116) can be displayed on the multi-purpose player window on the display. Moreover, optional visualizations (e.g., changing patterns) can also be sized and displayed within the multi-purpose player window on the display while each song is opened (or played) at operation 614.

At operation 614 of FIG. 6, it is noted that the multi-purpose player can utilize API commands to communicate and control the appropriate application player engine utilized to access the electronic content. Note that an association table can be referenced in order to determine which API commands to utilize when communicating with different application player engines. In one embodiment, the API commands can be implemented as ActiveX® controls or Common Object Model (COM) controls (or similar standards or technologies) that can be used for communicating and controlling one or more application player engines.

Within method 600, within one embodiment, since the GUI can launch the appropriate application player engine itself, it can be in control of where images and the like are displayed along with what it is hooked into of that application. As such, the GUI can cause the application engine to display visual content within the multi-purpose player window of the GUI. Within this embodiment, the GUI can launch the appropriate application player engine directly and then feeding it the content. It is appreciated that the application player engine utilized by the GUI to access selected electronic content may be different from a default player engine utilized by a computer operating system to access the same content. One reason for this can be that the GUI may be using its own internal association table to determine the appropriate player engine for particular content.

Once operation 614 is completed, method 600 can then return to operation 606 where the GUI is ready for use. Note that if any other link is dragged (e.g., at operation 608) and dropped onto the sensitive area of the multi-purpose player window (e.g., at operation 610), the GUI can determine which application is capable of accessing the content (e.g., at operation 612) and then can open it with the appropriate application (e.g., at operation 614) while the multi-purpose player window remains as the user interface for that content.

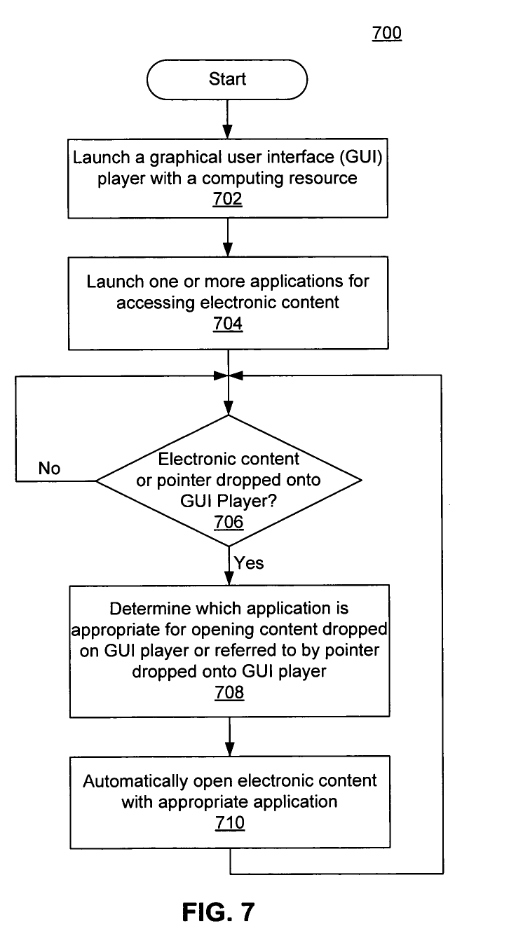

FIG. 7 is a flowchart of a method 700 in accordance with embodiments of the invention for opening electronic content. Method 700 includes exemplary processes of embodiments of the invention which can be carried out by a processor(s) and electrical components under the control of computing device readable and executable instructions (or code), e.g., software. The computing device readable and executable instructions (or code) may reside, for example, in data storage features such as volatile memory, non-volatile memory, and/or mass data storage that are usable by a computing device. However, the computing device readable and executable instructions (or code) may reside in any type of computing device readable medium. Although specific operations are disclosed in method 700, such operations are exemplary. That is, method 700 may not include all of the operations illustrated by FIG. 7. Alternatively, method 700 may include various other operations and/or variations of the operations shown by FIG. 7. Likewise, the sequence of the operations of method 700 can be modified. It is noted that the operations of method 700 can each be performed by software, by firmware, by hardware, or by any combination thereof.

Specifically, a graphical user interface (GUI) player can be launched or started-up with a computing resource. Additionally, one or more applications for accessing electronic content can be launched by the computing resource. It is noted that the GUI player can launch the one or more applications. A determination can be made as to whether electronic content or a pointer referencing electronic content has been dropped onto the GUI player. If not, the determination can be repeated. However, if so, it is determined which application is appropriate for (or capable of) opening the electronic content that was either dropped onto the GUI player or referred to by the pointer dropped onto the GUI player. The electronic content can be automatically opened with the appropriate application, for example, while utilizing the GUI player as the user interface for that content. Method 700 can then return to the determination as to whether electronic content or a pointer referencing electronic content has been dropped onto the GUI player. Note that if any other pointer or content is dropped onto the GUI player, it is determined which application is capable of accessing the content and then the content is opened with the appropriate application, for example, while the GUI player remains as the user interface for that content.

At operation 702 of FIG. 7, a graphical user interface (GUI) player (e.g., 114 or 114a) can be launched or started-up by a computing resource. Operation 702 can be implemented in a wide variety of ways. For example, the GUI player can be automatically launched at operation 702 during startup of the computing resource. Alternatively, the GUI player can be launched at operation 702 in response to a user selecting it. In another embodiment, the GUI player can be automatically launched at operation 702 by another application. Note that operation 702 can be implemented in any manner similar to that described herein, but is not limited to such.

At operation 704, one or more applications (e.g., player engines and the like) for accessing electronic content can be launched by the computing resource. Operation 704 can be implemented in diverse ways. For example, operation 704 can be implemented to occur concurrently while the GUI player is being launched at operation 702. Additionally, while the GUI player is launching, the GUI player can initiate the launch at operation 704 of the one or more applications for accessing electronic content. The one or more applications of operation 704 can be implemented as any type of electronic content “player” engine. For example, the content player engine can be implemented in any manner similar to that described herein, but is not limited to such. It is appreciated that operation 704 can be implemented in any manner similar to that described herein, but is not limited to such.

At operation 706 of FIG. 7, a determination can be made as to whether electronic content or a pointer (or link) referencing electronic content has been dropped onto the GUI player. If it is determined at operation 706 that neither has been dropped onto the GUI player, process 700 proceeds to the beginning of operation 706 to repeat the determination. However, if it is determined that electronic content or a pointer to electronic content has been dropped onto the GUI player at operation 706, process 700 proceeds to operation 708. It is appreciated that operation 706 can be implemented in a wide variety of ways. For example, operation 706 can be implemented in any manner similar to that described herein, but is not limited to such.

At operation 708, it is determined which application is appropriate for (or capable of) opening or accessing the electronic content that was either dropped onto the GUI player or referred to by the pointer dropped onto the GUI player. It is understood that operation 708 can be implemented in diverse ways. For example, operation 708 can be implemented in any manner similar to that described herein, but is not limited to such.

At operation 710 of FIG. 7, the electronic content can be automatically opened with the appropriate application. It is noted that operation 710 can be implemented in a wide variety of ways. For example, the electronic content can be automatically opened with the appropriate application at operation 710 while utilizing the GUI player (e.g., 114 or 114a) as the user interface for that content. Note that operation 710 can be implemented in any manner similar to that described herein, but is not limited to such. Once operation 710 is completed, method 700 can proceed to operation 706. As such, when any other pointer or content is dropped onto the GUI player (e.g., at operation 706), it is determined which application is capable of accessing the content (e.g., at operation 708) and then the content is opened with the appropriate application (e.g., at operation 710), for example, while the GUI player remains as the user interface for that content.

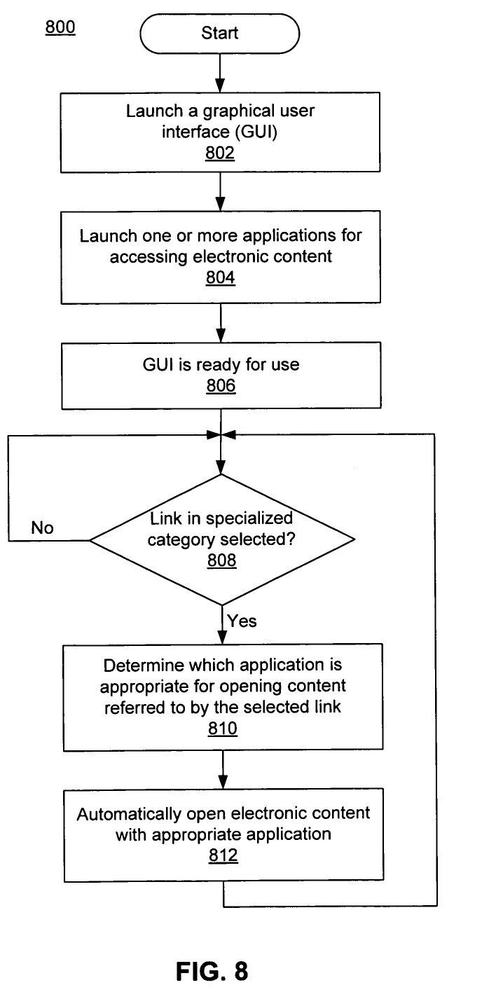

FIG. 8 is a flowchart of a method 800 in accordance with embodiments of the invention for opening electronic content. Method 800 includes exemplary processes of embodiments of the invention which can be carried out by a processor(s) and electrical components under the control of computing device readable and executable instructions (or code), e.g., software. The computing device readable and executable instructions (or code) may reside, for example, in data storage features such as volatile memory, non-volatile memory, and/or mass data storage that are usable by a computing device. However, the computing device readable and executable instructions (or code) may reside in any type of computing device readable medium. Although specific operations are disclosed in method 800, such operations are exemplary. That is, method 800 may not include all of the operations illustrated by FIG. 8. Alternatively, method 800 may include various other operations and/or variations of the operations shown by FIG. 8. Likewise, the sequence of the operations of method 800 can be modified. It is noted that the operations of method 800 can each be performed by software, by firmware, by hardware, or by any combination thereof.

Specifically, a graphical user interface (GUI) can be launched by a computing resource. Additionally, one or more applications for accessing electronic content can be launched by the computing resource. It is noted that the GUI can launch the one or more applications. Subsequently, the GUI can be ready for use. A determination can be made as to whether a pointer (or link) referencing electronic content has been selected that is located in a specialized category of the GUI. If not, the determination can be repeated. However, if so, the GUI can consult its own association table to determine which application is appropriate for (or capable of) opening the electronic content corresponding to the selected pointer. The electronic content can be automatically opened with the appropriate application, while utilizing a multi-purpose player (e.g., 114 or 114a) of the GUI as the user interface for that content. Method 800 can then return to the determination as to whether a link in a specialized category has been selected. Note that if any other link has been selected, it can be determined which application is capable of accessing the content and then the content is opened with the appropriate application, while the multi-purpose player remains as the user interface for that content.

At operation 802 of FIG. 8, a graphical user interface (e.g., 100) can be launched by a computing resource. It is appreciated that operation 802 can be implemented in a wide variety of ways. For example, operation 802 can be implemented in any manner similar to that described herein, but is not limited to such.

At operation 804, one or more applications (e.g., player engines and the like) for accessing electronic content can be launched by the computing resource. Operation 804 can be implemented in diverse ways. For example, operation 804 can be implemented in any manner similar to that described herein, but is not limited to such.

At operation 806 of FIG. 8, the GUI is ready for use. It is understood that the GUI can be utilized by one or more users of the computing resource, but is not limited to such. The GUI of operation 806 can be implemented in any manner similar to that described herein, but is not limited to such.

At operation 808, a determination can be made as to whether a pointer (or link) referencing electronic content has been selected that is located in a specialized category (e.g., 112) of the GUI. If it is determined at operation 808 that a pointer in a specialized category has not been selected, process 800 proceeds to the beginning of operation 808 to repeat the determination. However, if it is determined that a pointer in a specialized category has been selected at operation 808, process 800 proceeds to operation 810. It is appreciated that operation 808 can be implemented in a wide variety of ways. For example, operation 808 can be implemented in any manner similar to that described herein, but is not limited to such.

At operation 810 of FIG. 8, it is determined which application is appropriate for (or capable of) opening or accessing the electronic content that was referred to by the pointer selected in the specialized category of the GUI. It is understood that operation 810 can be implemented in diverse ways. For example, an appropriate application may have be predetermined and stored within a content association table (e.g., Table 1) that the GUI utilizes at operation 810. Note that operation 810 can be implemented in any manner similar to that described herein, but is not limited to such.

At operation 812, the electronic content can be automatically opened with the appropriate application while utilizing the multi-purpose player (e.g., 114 or 114a) of the GUI as the user interface for that content. It is noted that operation 812 can be implemented in a wide variety of ways. For example, operation 812 can be implemented in any manner similar to that described herein, but is not limited to such. Once operation 812 is completed, method 800 can proceed to operation 808. Note that if any other link has been selected (e.g., at operation 808), it can be determined which application is capable of accessing the content (e.g., at operation 810) and then the content can be opened with the appropriate application (e.g., at operation 812), while the multi-purpose player remains as the user interface for that content.

One or more embodiments in accordance with the invention can be implemented as a graphical user interface (e.g., 100) which can include the functionality as a portal to the Internet or other network as well as to content stored on the hard drive of a computing resource. Through the graphical user interface, the user can activate applications such as video player applications, music player applications, word processor applications, spreadsheet applications, Internet browsers, and more. The graphical user interface can include multiple specialized modules. Some of these modules can be categories (e.g., 105-113) which can contain both predefined and user-defined links to content online and on the hard drive of the computing resource. Note that one of the modules within the graphical user interface can be a multi-purpose player window (e.g., 114), which can serve as a launching pad for electronic content contained in the categories of the GUI, the computing resource itself, and/or the Internet, but is not limited to such. Pointers to content or content files can be dragged and dropped onto the multi-purpose window (e.g., 114) for automatic launching, regardless of the application utilized to open the content.

Another module within the graphical user interface (e.g., 100) can be a search tool (e.g., 115). Using this search tool, users can search the computer resource itself or a network with a user-selected online search engine. The skin (e.g., 119) of the graphical user interface can be user-customizable. Additionally, the skin can also be modified by a third party through the Internet or other network. In this way, the graphical user interface can be used by selected business partners as an advertising tool, a recruiting tool, etc. The graphical user interface can be configured such that user changes and certain user behaviors can be tracked. Data collected in this way can be used to establish and maintain a user profile associated with the customizable graphical user interface. The user profile can be used by the administrator of the graphical user interface or by designated third parties to determine the “needs”, habits and preferences of the user.

The foregoing descriptions of specific embodiments of the invention have been presented for purposes of illustration and description. They are not intended to be exhaustive or to limit the invention to the precise forms disclosed, and obviously many modifications and variations are possible in light of the above teaching. The invention can be construed according to the claims and their equivalents.

1. A method comprising:
launching a graphical user interface player with a computing resource;
launching a plurality of applications for accessing electronic content, said launching concurrent with said launching said graphical user interface player; and
automatically opening an electronic content in response to the dropping of a pointer to said electronic content onto said graphical user interface player.

2. The method of claim 1, wherein said automatically opening said electronic content comprises utilizing an application of said plurality of applications.

3. The method of claim 1, further comprising:
determining which application of said plurality of applications is appropriate for opening said electronic content in response to the dropping of said pointer onto said graphical user interface player.

4. The method of claim 3, wherein said determining comprises utilizing metadata associated with said electronic content.

5. The method of claim 1, wherein said electronic content is stored by said computing resource.

6. The method of claim 1, wherein said electronic content is stored by a network computing resource.

7. The method of claim 1, wherein said graphical user interface player comprises a sensitive area for detecting said dropping of said pointer.

8. The method of claim 1, wherein said electronic content is audio, video, an digital image, a graphics image, or text.

9. A computer-usable medium having computer-readable code embodied thereon for causing a computing resource to perform a method comprising:
launching a graphical user interface comprising a content player;
launching a plurality of applications capable of accessing electronic content, said launching concurrent with said launching of said graphical user interface; and
automatically accessing an electronic content in response to the dropping of a link to said electronic content onto a sensitive area of said content player of said graphical user interface.

10. The computer-usable medium of claim 9, wherein said automatically accessing said electronic content comprises utilizing an application of said plurality of applications.

11. The computer-usable medium of claim 9, wherein said method further comprising:
determining which application of said plurality of applications is appropriate for accessing said electronic content in response to the dropping of said pointer onto said sensitive area of said content player.

12. The computer-usable medium of claim 11, wherein said determining comprises utilizing metadata associated with said electronic content.

13. The computer-usable medium of claim 9, wherein said electronic content is stored by said computing resource.

14. The computer-usable medium of claim 9, wherein said electronic content is stored by a computing resource coupled to a network.

15. The computer-usable medium of claim 9, wherein said electronic content is audio, video, an digital image, a graphics image, or text.

16. The computer-usable medium of claim 9, wherein said graphical user interface further comprises a category module that includes said link.

17. The computer-usable medium of claim 16, wherein said graphical user interface further comprises a search tool for searching said computing resource or a network.

18. A method comprising:
launching a graphical user interface player with a computing resource;
launching a plurality of applications for accessing electronic content, said launching said plurality of applications concurrent with said launching said graphical user interface player; and
automatically opening an electronic content in response to the dropping of said electronic content onto said graphical user interface player.

19. The method of claim 18, wherein said automatically opening said electronic content comprises utilizing an application of said plurality of applications.

20. The method of claim 18, further comprising:
determining which application of said plurality of applications is proper for opening said electronic content in response to the dropping of said electronic content onto said graphical user interface player.

21. The method of claim 20, wherein said determining comprises utilizing metadata corresponding to said electronic content.

22. The method of claim 21, wherein said determining further comprises utilizing an association table.

23. The method of claim 18, wherein said graphical user interface player comprises a detection area for detecting said dropping of said electronic content.
